(19) United States
(12) Patent Application Publication
(10) Pub. No.: US 2007/0169550 A1
(43) Pub. Date: Jul. 26, 2007

(54) Educational accelerometer

(76) Inventor: Robert William Lally, Orchard Park, NY (US)

Correspondence Address: ROBERT WILLIAM LALLY, 7 EAGLE HEIGHTS DRIVE, ORCHARD PARK, NY, 14127, US

(21) Appl. No.: 11/340,160

(22) Filed: Jan. 26, 2006

(51) Int. Cl. G01P 15/00

(52) U.S. Cl. 73/488

(57) ABSTRACT

For testing the behavior and monitoring the health of things, a novel, simple, low cost, highly sensitive, light weight, easy to install, flexibly wired, sophisticated accelerometer senses the motion of educational structural models that demonstrate eneraction—how the world and sensors work. A modified electret microphone with a mass adhesively attached to its diaphragm is embedded in a hard rubber housing, insulating it against environmental noise and temperature changes. Residual stresses in the housing, which plugs onto and grips a post protruding from the test object, ensures intimate interface surface contact and faithful transmission of motion. Containing an internal isolation amplifier, and operating over two ordinary wires, the sensor embodies popular, ICP (integrated-circuit-piezoelectric) technology. Standard telephone cable output connectors mate with educational, data-acquisition accessories for computers.

### CROSS REFERNECE TO RELATED APPLICATION

Not applicable

### STATMENT REGARDING FEDERALLY SPONSERED RESEARCH OR DEVELOPMENT

Not applicable

### BACKGROUND OF THE INVENTION

The present invention generally relates to education and demonstration, and to measuring and testing. More specifically it relates to a sophisticated, low-cost, integrated-circuit-electrostatic (ICE), plug-on sensor for electronically sensing motion involved in the behavior testing and health monitoring of educational structural models sensibly demonstrating eneraction—what makes the world and sensors work.

Various types of physical models have been employed for ages to help teach science and technology, and to explore reality. Applying modem technology, many such educational models now employ computers displaying signals from electronic sensors to facilitate learning and teaching. Among the multitude of structural models and sensors available today, obvious wants and needs still exist for new and improved sensors to demonstrate and explore sensing and communicating, gravimetric calibration, the behavior testing and health monitoring of things, including sensors, and eneraction. Related science and technology experiments tend to integrate rather fragmented knowledge and experience back into a unified whole.

Eneraction, a new word, explains how the world and sensors work—how sensors and senses structurally sense and communicate? Eneractively, through transfers of energy: physical, mental, and spiritual, forces of nature and man move and bend things, trigger and power events, and sense and communicate information. Likewise, eneractively, through transfers of mechanical and electrical energy, forces deflecting elastic sensor structures transfer physical phenomena into electrical signals. Sensors are not mystical devices.

Knowledge gained physically testing models extends by analogy to mental and spiritual realms. For example, through transfers of energy, physically force moves objects, mentally feeling stimulates thought, and spiritually, spirit inspires action. Moreover, ancient wisdom encourages us to test all things, and retain what is good.

Industrial sensors are usually too big and expensive for use on desktop, educational, structural models. Although some modern semiconductor strain gage and MEMS (Micro-Electro-Mechanical Systems) type sensors are now being used on educational models, they present complex cabling and mounting problems. In another field, acoustics, small electret microphones employing popular ICP (integrated circuit piezoelectric) technology operating over flexible, two-wire cables to make similar low-level measurements. Modified, these modern marvels show promise for motion sensing, but present other problems. They are sensitive to humidity and moisture, and need to be sealed and vented. Enlarged internal passages reduce damping, and sluggish behavior.

Because of the mass of the elastic diaphragm material, such microphones are inherently sensitive to motion. Adding mass to the diaphragm increases the acceleration sensitivity, and adapts them for use on structural models. But, finding practical ways to permanently attach the mass to the diaphragm, environmentally seal the assembly, sufficiently vent, and conveniently install has stymied development.

Although the polarized capacitor sensing element in electret microphones is a simulated piezoelectric crystal, popular ICP technology when used with microphones ought to be more generally termed ICE (Integrated Circuit Electrostatic). ICP is a subclass of ICE. Like electret capacitors, piezoelectric quartz crystals are electrostatic in nature. ICP technology involves an isolation amplifier inside the sensor operating over two ordinary wires. One wire carries both signal and power, creating a bias voltage on the output. The other wire is ground.

Thus, a want and need exists for a low cost, high sensitivity, easy to mount, flexibly cabled, sealed, ICE, educational accelerometer, which the present invention addresses.

### BRIEF SUMMARY OF THE INVENTION

Accordingly, most of the above wants and needs are met by the present invention of a modified, popular, commercial, electret microphone sealed in a thin vinyl cap, and embedded in a hard rubber housing having a hole for mounting by plugging onto an oversize mating post on the test object.

Modifications include carefully attaching a small mass to the central part of the microphone diaphragm with a silicone adhesive that remains flexible and withstands elevated temperatures, and drilling holes in the microphone casing to enlarge internal cavities. Filling with wax or a sealant the open end of the plastic cap where the wires protrude hermetically seals the assembly. The outside diameter of the plastic cap of the microphone assembly the snugly fits in a central round hole in the cylindrical housing. The two flexible wires for electrical connection to external signal and power conditioning circuitry protrude through a small hole in one end of the housing, and are gripped by its wall.

For quick, easy installation and removal, the central hole in the elastic housing also snuggly fits and grips an oversize mating post protruding from the test subject. Residual stresses in the elastic housing firmly press and hold the mating interface surfaces together in intimate contact, ensuring faithful transmission of motion, and accurate alignment of the sensitive, cylindrical axis of the accelerometer normal to the mounting surface.

The popular, low-cost, electret microphone, now produced by the millions for toys and cell phones, incorporates a built-in ICP type isolation amplifier that operates over two flexible wires from a computer expanded to display electronic signals, like an oscilloscope.

For a differential sensor with improved linearity and sensitivity operating over three wires, two modified microphone capsules are assembled face to face in a common plastic cap, with their seismic masses adhesively connected to form a single unit,

Structural behavior of both the microphone assembly and the housing is adequate for measurements on existing swing, free-fall, and beam type educational structural models. First resonances are above 1000 Hertz. During calibration, the sensor faithfully follows a square wave of known, one g, input motion, with a rise time of less than three milliseconds, and no appreciable signal decay over a 50 millisecond time interval.

Therefore the primary object of this invention is a low-cost, sensitive, rugged, light weight, flexibly cabled, easy-to-install, accelerometer for sensing the motion of educational structural models during experiments testing the behavior and monitoring the health monitoring of things.

Another object of this invention is a typical sensor to demonstrate how sensors structurally sense and communicate through eneraction—the interactive transfer of energy.

Another object of this invention is an educational accelerometer with flexible wiring to demonstrate free-fall calibration, and dynamic behavior testing of sensors.

Still another object of this invention is a sensor to demonstrate and explain popular, modern, ICP (integrated-circuit-piezoelectric) technology.

### BRIEF DESCRIPTION OF DRAWINGS

The structure of the preferred embodiment of the educational accelerometer and typical test results are illustrated in the following drawings, in which:

FIG. 1 is a sectioned side elevation view of a cylindrical version of the invention, and a partial sectioned view of the microphone showing the mass centrally attached to the diaphragm.

FIG. 2 is a similar partial sectional view showing a mechanical and electrical differential version of the sensing capsule of the invention.

FIG. 3 is an X/Y display of the horizontal and vertical motion signals of a coasting swing with a dot that follows its arcing path.

FIG. 4 is a display of the time history of a fast bungee-jumping event.

FIG. 5 graphs the motion signal versus time of a cantilever beam, diving-board model, when impulsively disturbed.

FIG. 6 shows the sensitivity and behavior of the invention when subjected to a known, one g square wave of acceleration during a quick, free-fall, drop test.

### DETAILED DESCRIPTION OF INVENTION

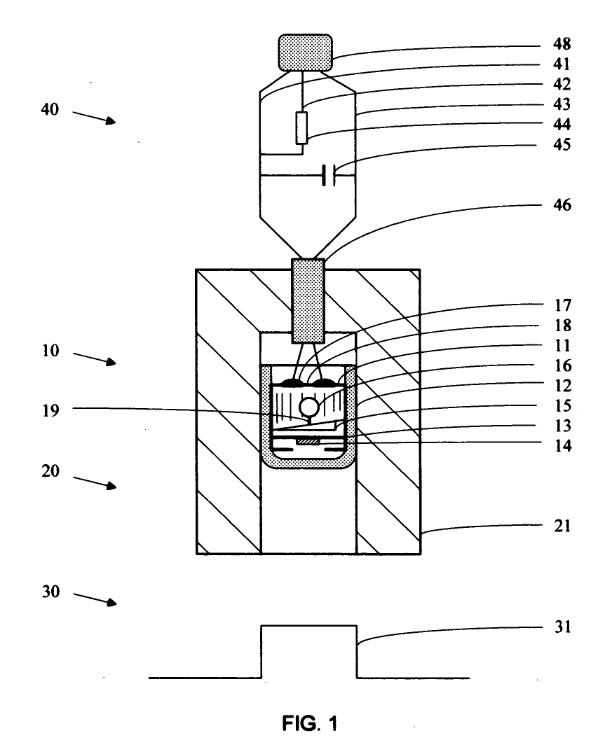

FIG. 1 illustrates an educational accelerometer containing a modified electret microphone 11 with a mass 14 adhesively attached to its diaphragm 13, sealed in a vinyl plastic cap 12, and embedded in a hard rubber housing 21 that plugs onto a post protruding from a test object 31. Snug fits, residual stresses, and friction at mating interface surfaces clamp and hold the light weight parts together, and facilitate assembly, installation, and removal.

Through transfers of energy as force and motion, the sensor capsule 10 structurally senses motion of the test object 30. Transferring energy, when the housing 21 plugs onto a mating post 31 protruding from a test object 30, and is accelerated in a direction normal to the plane of said diaphragm 13, the force required to accelerate mass 14 to follow the motion of housing 21 deflects diaphragm 13, generating an output signal from said ICP microphone assembly 10 representing the acceleration aspect of motion being experienced.

Deflection of the diaphragm 13 changes the capacitance between it and a backup plate 15, which converts into an electrical signal for display on a computer monitor expanded to act like an oscilloscope.

The pre-polarized, electret capacitor 14, 15 acts as a simulated piezoelectric crystal in a typical ICP (integrated-circuit-piezoelectric) system. An ICP isolation amplifier inside the microphone prevents external circuitry from discharging the capacitor and eliminating the signal. When connected to a computer through a data acquisition device, plus 5 volt USB power is supplied through lead 42 and resistor 44 over the signal lead 41. An optional filter capacitor 45 attenuates high frequency electrical noise.

Conveniently installed in a small module or bulge in the cable, resistor 44 and filter capacitor 45 form a typical ICP coupling unit. Standard telephone connector 48 plugs directly into commercially available, low-cost, educational, data acquisition instruments. The flexible, ordinary, two wire cable allows measurements on moving objects without introducing significant spurious cable forces. High level signals obviate the need for shielding in most situations.

The so-called seismic or proof mass 14 in the educational accelerometer is a thin disk of heavy metal material, such as brass, bonded to the center of the elastic diaphragm 13 with a flexible silicone adhesive that can withstand elevated temperatures. Holes 16 drilled through the side of the microphone 10 case enlarge internal passages to reduce air damping, and allow the diaphragm 13 more freedom to move. A small groove or saw slot 19 in the surface of the microphone 11 connects the hole 15 to the end chamber of the plastic cap 12 to equalize static pressure across the diaphragm 13.

The sealing means is a cylindrical plastic cap 12 housing the microphone assembly and having its open end coated and sealed with pliable petrowax 18. The wax 18 also effectively seals the exposed top surface of the electret microphone 11, which, like the ultra high impedance piezoelectric crystal device it simulates, is notoriously sensitive to moisture and humidity.

The housing 21 is a cylindrical body of stiff, hard rubber, elastic material having a hole for mounting, and a cavity containing the modified microphone 11. The mounting hole connects to and grips a mating post 31 protruding from the test object 30. The housing 21 transfers motion of the test object 31 to the microphone assembly 10, aligns the microphone 11 with the test object 31, insulates it against environmental noise and temperature changes, and facilitates installation and removal of the accelerometer. Residual stresses in the hard, elastic housing 12, force and hold mating surfaces in intimate contact. This intimate interface contact ensures faithful transmission of motion between the test object and the sensing element over the frequency range of interest in educational experiments.

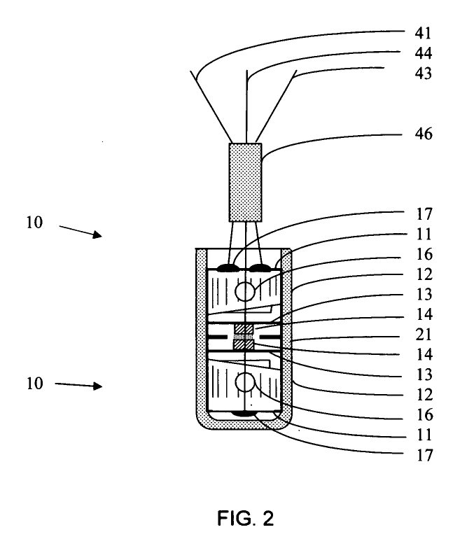

Operating over three wires 41,42, 43, FIG. 2 illustrates a mechanical and electrical differential version of the sensing capsule 10 of the educational accelerometer having improved linearity and twice the sensitivity of the one capsule design. Two identical, electret sensing capsule assemblies 10 are connected face to face in a common elongated plastic sleeve 12, and their masses 14 mechanically connected to each other with an adhesive 21 to act as single unit. Installed directly in a hole in a test object 30, this differential capsule could be used independently, as pictured, to sense acceleration. It normally mounts in a housing 21, like the single unit 11.

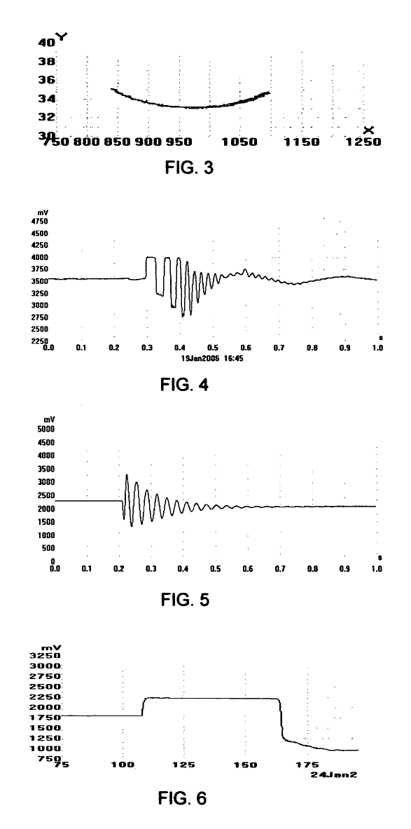

As illustrated in FIG. 3 through FIG. 6, performance and behavior of this low-cost educational sensor are adequate for educational use. FIG. 3 is an X/Y display of horizontal and vertical motion signals of a coasting, glider type swing. A dot on the screen of the monitor following the arcing, oscillating motion of the swing builds confidence in the sensors and associated instrumentation. The other figures are graphs of the time histories of various signals.

FIG. 6 shows typical gravimetric calibration and behavior signal resulting from a quick, free-fall, drop test in the earths' gravity field. Sensitivity of this particular accelerometer is 440 millivolts per g. Rise time is less than 3 milliseconds. Signal decay over a 50 millisecond time period is negligible. Without the filter capacitor 45 in the circuit, test results show the resonant frequency of the mass 14 and elastic diaphragm 13 substructure, which the disturbance excites, to be 14 kilohertz.

The sensitive axis of the educational accelerometer is along the central axis of the cylindrical housing 21. Sensors capsules 10 for measuring in other directions can also be embedded in the thick side walls of same elastic housing 21. While the electrostatic, polarized capacitance, electret microphone capsule offers simple cabling, behavior, and cost advantages, the novel, rugged, stiff, elastic housing can also readily accommodate other type miniature accelerometer capsules, such as resistive strain gage, passive capacitive, or MEMS. Such an integrated, rugged, educational accelerometer assembly offers several advantages.

Simple, quick, plug-on installation and removal of light weight, motion sensors equipped with flexible cables and standard telephone connectors is a real advantage for student experimenters and teachers. These features facilitate many traditional and new science and technology experiments, such as swing, bungee-jumper, diving board, Newton's laws, behavior testing, health monitoring, sensing and communicating, gravimetric calibration, and eneraction, which, as mentioned and illustrated, is what makes the world and sensors work.

I claim:

1. An educational accelerometer for sensing the motion of structural models comprising:
a modified electret microphone having an elastic diaphragm sensing surface;
a mass bonded to the center of said diaphragm;
a housing containing said modified microphone, and having a mounting hole for connecting to a test object;
a sealing means;
whereby when said housing plugs onto a mating post protruding from a test object, and is accelerated in a direction normal to the plane of said diaphragm, the force required to accelerate said mass to follow the motion of said housing deflects said diaphragm, generating an output signal from said microphone representing the acceleration aspect of motion being experienced.

2. The educational accelerometer of claim 1, wherein said mass is a thin disk of heavy metal material bonded to the center of said diaphragm with a flexible adhesive.

3. The educational accelerometer of claim 1, wherein said housing is a cylindrical body of hard elastic material having a mounting hole that connects to and grips a mating post protruding from said test object, and that has a cavity containing said modified microphone, whereby said housing transfers motion of said test object to said microphone, aligns said microphone with said test object, insulates said microphone against environmental noise and temperature changes, facilitates installation and removal of said accelerometer, and residual stresses in said housing clamp and hold interface surfaces in intimate contact.

4. The educational accelerometer of claim 1, wherein said sealing means is a cylindrical plastic cap housing said microphone, whereby its open end sealed with wax.

5. An educational accelerometer for sensing the motion of structural models comprising:
two modified electret microphones having an elastic diaphragm sensing surface;
a mass bonded to the center of said diaphragm;
a housing containing said modified microphones, and having a hole for connecting to a test object;
a sealing means;
whereby when said modified microphones are connected face to face in said housing, their masses connected with an adhesive, the housing is mounted to a mating post protruding from a test object, and the test object is accelerated in a direction normal to the plane of said diaphragm, the force required to accelerate said mass assembly to follow the motion of said housing deflects said diaphragms, generating a differential output signal representing the acceleration aspect of motion being experienced.

6. An educational accelerometer assembly for sensing the motion of structural models comprising:
an accelerometer;
a stiff, elastic housing made of hard rubber material containing said accelerometer, and having a hole for connecting to a test object;
whereby when said housing is mounted on and grips a mating post protruding from a test object, and accelerated in the direction of the sensitive axis of said accelerometer, said accelerometer generates an output signal representing the acceleration aspect of motion being experienced.
